(19) United States
(12) Patent Application Publication
(10) Pub. No.: US 2006/0137961 A1
(43) Pub. Date: Jun. 29, 2006

(54) Direction key structure for preventing correlated action

(75) Inventors: Tsung Kai Lin, Taipei City (TW); Lii Hwang Chen, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: TATUNG CO., LTD., Taipei City (TW)

(21) Appl. No.: 11/142,351

(22) Filed: Jun. 2, 2005

(30) Foreign Application Priority Data
Dec. 29, 2004 (TW) 093141123

(51) Int. Cl. H01H 19/00

(52) U.S. Cl. 200/6 A

(57) ABSTRACT

This invention discloses a direction key structure that prevents correlated action, the simultaneous activation of two directions. By using a center shaft for a fulcrum, and in cooperation with four direction ribs set under a direction key housing, the direction key housing can act as a joystick. Four rods for preventing correlated action are set under the key direction housing, and each rod is set between two neighboring direction ribs so that the correlated action is avoided.

### BACKGROUND OF THE INVENTION

1. Field of the Invention

The present invention relates to a direction key structure, and more particularly, to a direction key structure for preventing correlated action in a media center extender.

2. Description of the Related Art

Many electronic products, such as TVs, video players, telephones, cell phones, etc, require different control keys, like number keys and direction keys. Recently, new designs incorporate four arrow keys into a single direction key to save on manufacturing costs.

However, a single direction key often has correlated action especially when more than one direction is selected at once, which is very inconvenient for users.

Therefore, it is desirable to provide a direction key structure that prevents correlated action to mitigate and/or obviate the aforementioned problems.

### SUMMARY OF THE INVENTION

The present invention provides a direction key structure for preventing correlated action, the structure comprises a keyboard printed circuit board, a plurality of press keys placed on the keyboard printed circuit board, and a direction key case, the direction key case has a button face, a top face, a plurality of direction ribs placed on the button face corresponding to the press keys on the keyboard printed circuit board, and a plurality of direction press areas placed on the top face corresponding to the press keys on the keyboard printed circuit board. By using a center stick for a fulcrum and cooperating with four direction ribs set under a direction key housing of the invention, the direction key housing can act as a joystick. Besides, four sticks for correlated action prevention are set under the key direction housing, and each stick is set between two neighboring direction ribs, so that the correlated action can be avoided.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an extender of an embodiment according to the present invention.

FIG. 2 is a schematic drawing of a direction key structure that prevents correlated action according to the present invention.

FIG. 3 is a cross-sectional drawing of the direction key structure that prevents correlated action according to the present invention.

FIG. 4 is a cross-sectional drawing of the direction key structure being pressed that prevents correlated action according to the present invention.

### DETAILED DESCRIPTION OF THE PREFERRED EMBODIMENT

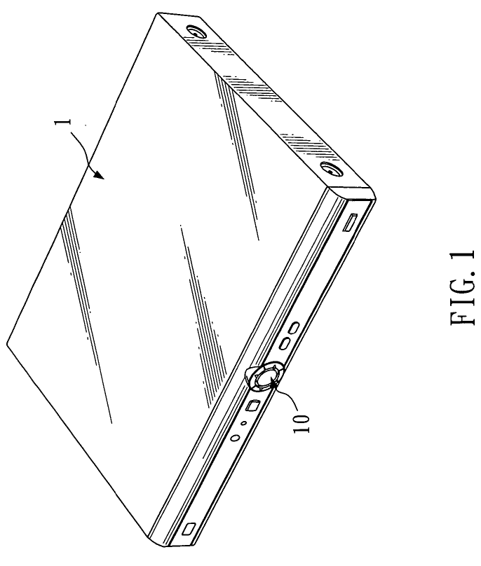

Please refer to FIG. 1. FIG. 1 is perspective view of an extender, especially an extension TV tuner of an embodiment according to the present invention. A direction key structure 10 that prevents correlated action according to the present invention is mounted in an extension TV tuner box 1.

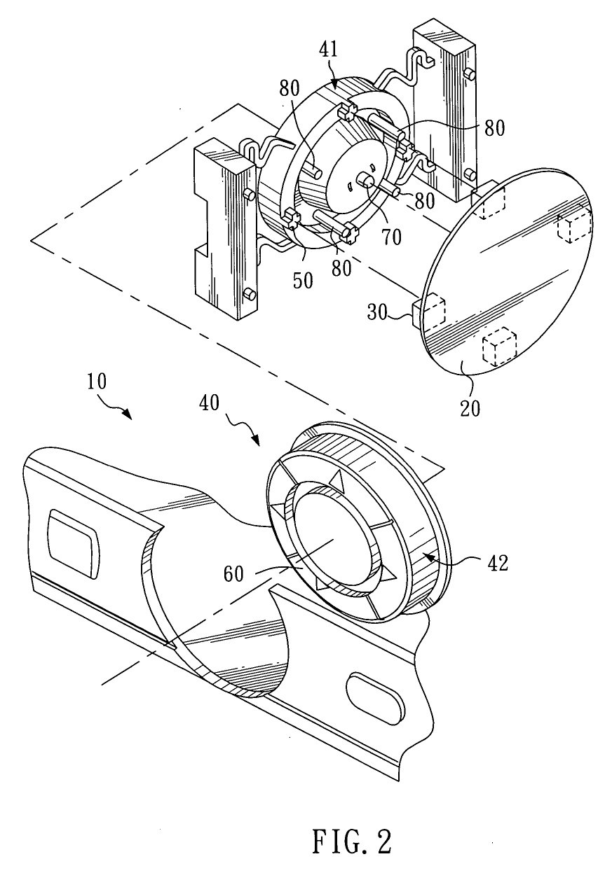

FIG. 2 is a schematic drawing of a direction key structure that prevents correlated action according to the present invention. As shown in the drawing, the direction key structure 10 that prevents correlated action comprises a keyboard printed circuit board 20, a direction key case 40, and four press keys 30 placed on the keyboard printed circuit board 20.

The direction key case 40 is a round key, and has a button face 41, a top face 42, and four direction ribs 50 placed on the button face 41 of the direction key case 40 corresponding to the press keys 30 on the keyboard printed circuit board 20. Similarly, four direction press areas 60 are placed on the top face 42 of the direction key case 40 corresponding to the press keys 30 on the keyboard printed circuit board 20. The button face 41 of the direction key case 40 has a center shaft 70 and four rods 80 for preventing correlated action; every rod 80 is separately placed between two direction ribs 50 on the button face 41 of the direction key case 40, and a moveable range of the direction rib 50 is greater than the corresponding moveable range of the rod 80.

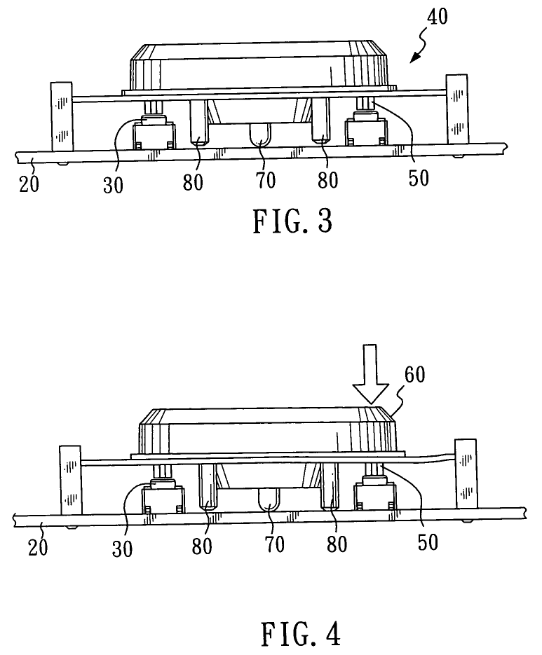

Please refer to FIG. 3. FIG. 3 is a cross-sectional drawing of the direction key structure for preventing correlated action according to the present invention. As shown in the drawing, the center shaft 70 of the direction key case 40 can touch the keyboard printed circuit board 20. Without any applied external force, the rods 80 for correlated action prevention and the keyboard printed circuit board 20 do not touch each other; similarly, the direction ribs 50 do not touch the press keys 30. But, if one area of the direction key case 40 is pressed down by touching the direction press area 60, and with reference to FIG. 4, the pressed direction press area 60 moves the corresponding direction rib 50 to touch the corresponding press key 30 on the keyboard printed circuit board 20. The rods 80 next to the above-mentioned direction rib 50 can touch the keyboard printed circuit board 20 to prevent the press keys 30 corresponding to other direction press areas 60 from being touched. Therefore, two adjacent direction press areas 60 will not suffer correlated action.

Although the present invention has been explained in relation to its preferred embodiment, it is to be understood that many other possible modifications and variations can be made without departing from the spirit and scope of the invention as hereinafter claimed.

What is claimed is:

1. A direction key structure for preventing correlated action comprising a keyboard printed circuit board, a plurality of press keys placed on the keyboard printed circuit board, and a direction key case, the direction key case having a button face, a top face, a plurality of direction ribs placed on the button face corresponding to the press keys on the keyboard printed circuit board, and a plurality of direction press areas placed on the top face corresponding to the press keys on the keyboard printed circuit board, the structure characterized in that:
The button face of the direction key case has a center shaft and a plurality of rods for preventing correlated action.

2. The direction key structure for preventing correlated action as claimed in claim 1, wherein a moveable range of the direction ribs is greater than the corresponding moveable stroke of the rods for preventing correlated action.

3. The direction key structure for preventing correlated action as claimed in claim 1, wherein the direction key case is a round key, four direction ribs are separately disposed on the button face of the direction key case, and four rods for preventing correlated action are separately placed between two direction ribs on the button face of the direction key case.
